(19) United States
(12) Patent Application Publication
(10) Pub. No.: US 2026/0059184 A1
(43) Pub. Date: Feb. 26, 2026

(54) IMAGE PICKUP APPARATUS

(71) Applicant: CANON KABUSHIKI KAISHA, Tokyo (JP)

(72) Inventor: TAKUYA IMAIZUMI, Kanagawa (JP)

(21) Appl. No.: 19/259,272

(22) Filed: Jul. 3, 2025

(30) Foreign Application Priority Data
Aug. 20, 2024 (JP) 2024-139249

(51) Int. Cl. H04N 23/52; G03B 17/55; H04N 23/54; H04N 23/68

(52) U.S. Cl. CPC H04N 23/52; G03B 17/55; H04N 23/54; H04N 23/687

(57) ABSTRACT

An image pickup apparatus includes a fixed unit, a movable unit movably held relative to the fixed unit and having an image sensor, and a heat conductive member configured to dissipate heat in a first direction from the movable unit to the fixed unit. The heat conductive member includes a folded portion that includes three folds arranged in order of a first mountain portion, a first valley portion, and a second mountain portion from a predetermined point to a first end in a second direction orthogonal to the first direction, and three folds arranged in order of a third mountain portion, a second valley portion, and a fourth mountain portion from the predetermined point to a second end opposite to the first end.

### BACKGROUND

### Field of the Technology

The present disclosure relates to one or more embodiments of an image pickup apparatus.

### Description of the Related Art

Japanese Patent Application Laid-Open No. 2021-189225 discloses a configuration in which a movable unit having an image sensor is movable relative to a fixed unit in two axial directions orthogonal to the optical axis (optical-axis orthogonal directions), and a heat conductive member is used to exchange heat between the fixed unit and the movable unit. This configuration reduces the load received from the heat conductive member when the movable unit moves relative to the fixed unit, without increasing the length of the path of the heat conductive member (while considering heat dissipation efficiency).

However, if an attempt is made to apply the heat conductive member disclosed in Japanese Patent Application Laid-Open No. 2021-189225 to a configuration in which the movable unit having the image sensor is movable not only in the optical-axis orthogonal direction but also in the optical axis direction, the heat conductive member may get damaged by the load received during movement in the optical axis direction.

### SUMMARY

One or more embodiments of an image pickup apparatus according to one or more aspects of the present disclosure may include a fixed unit, a movable unit movably held relative to the fixed unit and having an image sensor, and a heat conductive member configured to dissipate heat in a first direction from the movable unit to the fixed unit. The heat conductive member includes a folded portion that includes three folds arranged in order of a first mountain portion, a first valley portion, and a second mountain portion from a predetermined point to a first end in a second direction orthogonal to the first direction, and three folds arranged in order of a third mountain portion, a second valley portion, and a fourth mountain portion from the predetermined point to a second end opposite to the first end.

One or more embodiments of an image pickup apparatus according to one or more aspects of the present disclosure may include a fixed unit, a movable unit movably held relative to the fixed unit and having an image sensor, and a heat conductive member configured to dissipate heat from the movable unit to the fixed unit. The heat conductive member includes a folded portion that includes a first mountain portion and a second mountain portion from a predetermined point to a first end, a third mountain portion and a fourth mountain portion from the predetermined point to a second end, and a first valley portion between the first mountain portion and the second mountain portion.

Features of the present disclosure will become apparent from the following description of embodiments with reference to the attached drawings. The following description of embodiments is described by way of example..

### BRIEF DESCRIPTION OF THE DRAWINGS

FIG. 1 is a schematic diagram of an image pickup apparatus according to this embodiment.

FIG. 2 is an exploded perspective view of an image stabilizing unit and heat conductive member in a camera body according to this embodiment.

FIG. 3 is a developed view of an expandable portion according to this embodiment.

FIGS. 4A, 4B, and 4C are views of the heat conductive member according to this embodiment with the expandable portion folded from three directions using trigonometry.

FIG. 5 is a schematic diagram of the folding portion according to this embodiment.

### DESCRIPTION OF THE EMBODIMENTS

Referring now to the accompanying drawings, a detailed description will be given of embodiments according to the present disclosure.

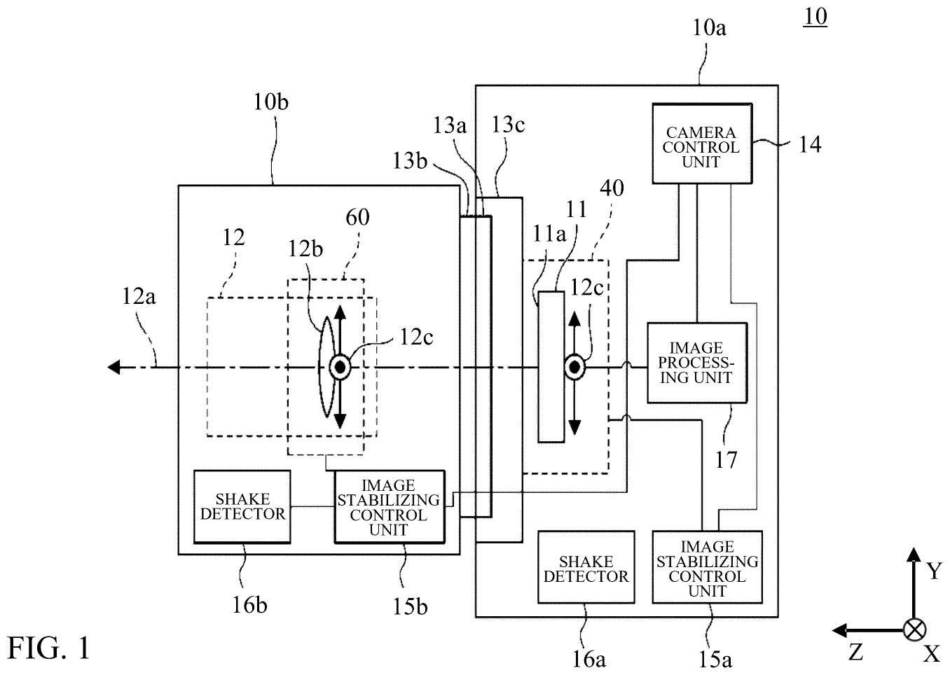

First, an imaging system 10 according to this embodiment will be described with reference to FIG. 1. FIG. 1 is a schematic diagram of the imaging system 10. The imaging system 10 is a so-called mirrorless digital camera, and includes a camera body (image pickup apparatus) 10a and a lens apparatus 10b attachable to and detachable from the camera body 10a. This embodiment is not limited to this example, and can also be applied to an image pickup apparatus in which the camera body and the lens apparatus are integrated.

The camera body 10a includes an image sensor 11 having an imaging surface 11a, a base member (fixed member) 13c, a camera mount member 13a, and a camera control unit 14. The camera body 10a further includes an image stabilizing control unit (first image stabilizing control unit) 15a, a shake detector (first shake detector) 16a, an image processing unit 17, and an image stabilizing unit (first image stabilizing unit) 40. The lens apparatus 10b includes an imaging optical system 12 including an image stabilizing lens 12b, a lens mount member 13b, an image stabilizing control unit (second image stabilizing control unit) 15b, a shake detector (second shake detector) 16b, and an image stabilizing unit (second image stabilizing unit) 60.

A virtual light ray representative of a light beam irradiated onto the imaging surface 11a of the image sensor 11 via the imaging optical system 12 is referred to as an optical axis (imaging optical axis) 12a. A plane orthogonal to the optical axis 12a will be referred to as an optical-axis orthogonal plane 12c, and a direction orthogonal to the optical axis 12a will be referred to as an optical-axis orthogonal direction. The optical axis 12a passes through the center of the imaging surface 11a and is orthogonal to the imaging surface 11a. In order to clarify the arrangement and positional relationship of components constituting the imaging system 10 within the imaging system 10, mutually orthogonal X-direction, Y-direction, and Z-direction are defined as illustrated in FIG. 1. The Z-axis direction is parallel to the optical axis 12a, the X-axis direction is a width direction of the imaging system 10, and the Y-axis direction is a height direction of the imaging system 10. In a case where the X-axis direction and the Z-axis direction are both in a horizontal plane, the Y-axis direction is a vertical direction. Therefore, the optical-axis orthogonal plane 12c is the XY plane.

The image sensor 11 includes a photoelectric conversion element such as a Complementary Metal-Oxide-Semiconductor (CMOS) image sensor or a Charge Coupled Device (CCD) image sensor. The image sensor 11 is disposed so that the imaging surface 11a faces the object side (lens apparatus 10b side) and is orthogonal to the optical axis 12a. The image sensor 11 generates an image signal by photoelectrically converting an optical image of an object formed on the imaging surface 11a by the imaging optical system 12. The image signal generated by the image sensor 11 is converted into image data through various processing by the image processing unit 17 and stored in a memory (storage device) (not illustrated).

The camera control unit 14 is an unillustrated calculator in a main IC, and controls the overall operation of the imaging system 10 by accepting input operations from a user via an operation unit (not illustrated).

The imaging optical system 12 includes a group of lenses (not illustrated) arranged inside the lens apparatus 10b, and forms an image of reflected light from an object (not illustrated) on the imaging surface 11a of the image sensor 11.

In the imaging system 10, in order to place the image sensor 11 with high positional accuracy relative to the optical axis 12a, the image sensor 11 is attached to the base member 13c provided on the camera body 10a, and the lens apparatus 10b is connected to the base member 13c. At that time, the image sensor 11 is attached to the base member 13c via the image stabilizing unit 40. The lens apparatus 10b is connected to the base member 13c via the lens mount member 13b and the camera mount member 13a.

The image stabilizing unit 40 corrects (reduces) an image blur caused by shake in the imaging system 10 by moving or rotating the image sensor 11 within the optical-axis orthogonal plane 12c orthogonal to the optical axis 12a in the imaging optical system 12, and enables a clear object image to be acquired. More specifically, when the orientation of the imaging system 10 changes relative to the object during imaging, an imaging position of an object light beam on the imaging surface 11a of the image sensor 11 changes, and a blur occurs in an image acquired through the image sensor 11. In this case, if the orientation change of the imaging system 10 is sufficiently small, a change in the imaging position is uniform within the imaging surface 11a and can be regarded as a translational or rotational movement (image plane blur) within the optical-axis orthogonal plane 12c.

Therefore, translating or rotating the image sensor 11 in the optical-axis orthogonal plane 12c so as to cancel the image blur can provide a clear object image in which the image blur has been corrected. In a case where the image sensor 11 moves in a direction parallel to the imaging surface 11a, the image sensor 11 may be movable in a direction orthogonal to the imaging surface 11a.

Similarly, the image stabilizing unit 60 corrects image blur caused by a shake occurring in the imaging system 10 by moving or rotating the image stabilizing lens 12b in the optical-axis orthogonal plane 12c, and enables a clear object image to be acquired. In other words, the optical axis 12a is refracted by moving the image stabilizing lens 12b in the optical-axis orthogonal plane 12c. At this time, the image stabilizing lens 12b is moved in the optical-axis orthogonal plane 12c so as to cancel the image blur. Thereby, a clear object image in which the image blur has been corrected can be obtained. The principle of the image stabilization by moving the image sensor 11 and the image stabilizing lens 12b is well known, and thus a detailed description thereof will be omitted. The image stabilizing lens 12b may also be movable in the optical axis direction when it is moved in the optical-axis orthogonal plane 12c.

The image stabilizing unit 40 includes, for example, a fixed unit, a movable unit, and a plurality of drive force generators. The fixed unit is fixed to the base member 13c, and the movable unit holds the image sensor 11. The movable unit is supported by the fixed unit with three degrees of freedom, and can move or rotate in the optical-axis orthogonal plane 12c relative to the fixed unit. In other words, the image stabilizing unit 40 is configured as a drive apparatus (a so-called XYθ stage) that can control drive in three axes, and can move or rotate the image sensor 11 in the optical-axis orthogonal plane 12c.

The image stabilizing unit 60 includes, for example, a fixed unit, a movable unit, and a plurality of drive force generators. The fixed unit is fixed to an unillustrated housing of the lens apparatus 10b, and the movable unit holds the image stabilizing lens 12b. The movable unit is supported by the fixed unit with two degrees of freedom, and can move relative to the fixed unit within the optical-axis orthogonal plane 12c. In other words, the image stabilizing unit 60 is configured as a drive apparatus (so-called XY stage) that can be drive-controlled in two axes, and can move the image stabilizing lens 12b within the optical-axis orthogonal plane 12c.

Each of the shake detectors 16a and 16b includes a gyro sensor or an acceleration sensor, and serves as a blur detector that detects the angular velocity or acceleration in each direction of the imaging system 10 as blur information on the imaging system 10.

Each of the image stabilizing control units 15a and 15b integrates the angular velocity or acceleration detected by the shake detectors 16a and 16b, respectively, and calculates an angular change amount or moving amount in each direction of the imaging system 10 as blur information. The image stabilizing control unit 15a calculates a target movement value for the image sensor 11 based on the shake information detected by the shake detector 16a, and controls the drive of the image stabilizing unit 40 to control the movement of the image sensor 11. Similarly, the image stabilizing control unit 15b calculates a target movement value for the image stabilizing lens 12b based on the shake information detected by the shake detector 16b, and controls the drive of the image stabilizing unit 60 to control the movement of the image stabilizing lens 12b.

In this embodiment, the imaging system 10 may have only the image stabilizing unit 40. In a case where the imaging system 10 does not have the image stabilizing unit 60, the image stabilizing lens 12b is basically unnecessary. In other words, the imaging optical system 12 in the lens apparatus 10b is designed to obtain the desired optical characteristic without the image stabilizing lens 12b.

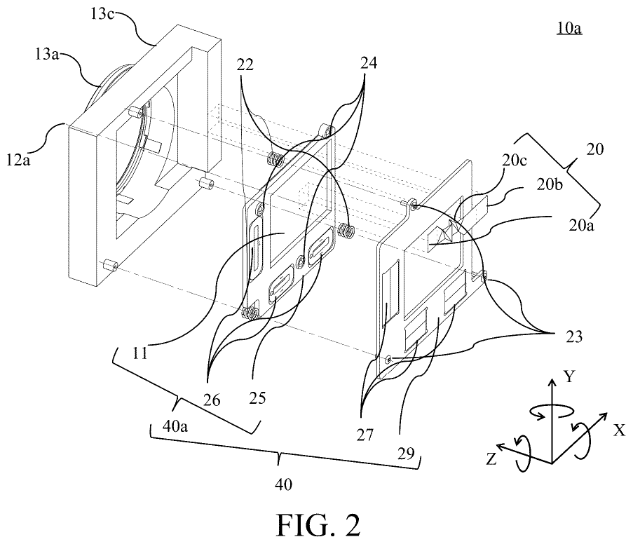

Referring now to FIG. 2, a description will be given of the heat dissipation configuration from the image sensor 11 according to this embodiment. FIG. 2 is an exploded perspective view illustrating a schematic configuration of the image stabilizing unit 40 and the heat conductive member 20 of the camera body 10a.

The image stabilizing unit 40 includes an image sensor 11, a movable unit (movable member) 40a that is driven in the optical-axis orthogonal plane 12c, and a sensor plate (base unit) 29 that holds the movable unit 40a and is attached to the base member 13c.

In this embodiment, the fixed unit includes the base member (first fixed member) 13c and the sensor plate (second fixed member) 29. The movable unit 40a is movable relative to the sensor plate 29 in the optical-axis orthogonal plane 12c. A distance between the movable unit 40a and the sensor plate 29 in the optical axis direction is kept constant. In this embodiment, the sensor plate 29 is held by a screw (holding member) 23 via a spring (elastic member) 22 movably in a direction approximately parallel to the optical axis 12a (optical axis direction) relative to the base member 13c. This configuration can easily adjust a distance from the camera mount member 13a to the image stabilizing unit 40 by adjusting a tightening amount of the screw 23. In other words, the distance in the optical axis direction between the base member 13c and the sensor plate 29 is adjustable. On the other hand, when a large external force is applied to the camera body 10a, the image stabilizing unit 40 may move in a direction along the optical axis 12a, and thus a variety of components may not get damaged in that case.

The movable unit 40a is configured so that the movable frame 25 is held against the sensor plate 29 via rolling balls 24. This keeps the distance in the optical axis direction between the movable unit 40a and the sensor plate 29 constant. The movable frame 25 holds the image sensor 11 and three coils 26.

A magnet 27 is disposed on the sensor plate 29 at a position facing the coil 26. The coil 26 and magnet 27 function as a set as a voice coil motor (VCM), and properly passing electricity through the coil 26 can move or rotate the movable unit 40a within the optical-axis orthogonal plane 12c.

The heat conductive member 20 is made of a sheet-like member such as a graphite sheet, and has a movable end (first end) 20a, a fixed end (second end) 20b, and an expandable portion 20c. The heat conductive member 20 is fixed to the image sensor 11 at the movable end 20a and to the base member 13c at the fixed end 20b, so that the heat conductive member 20 can efficiently transfer (dissipate) heat generated by the image sensor 11 to the base member 13c.

The expandable portion 20c of the heat conductive member 20 is formed by folding a sheet. The expandable portion 20c has an effect of absorbing deformation of the movable end 20a relative to the fixed end 20b at six axes. Due to this configuration, the heat conductive member 20 can suppress the load of the movable unit 40a on the sensor plate 29. In addition, the heat conductive member 20 does not become a load when the image stabilizing unit 40 moves relative to the base member 13c, and the heat conductive member 20 can be prevented from getting damaged.

In this embodiment, in order to realize more efficient heat dissipation, the movable end 20a of the heat conductive member 20 is fixed to the image sensor 11, and the fixed end 20b is fixed to the base member 13c, but this embodiment is not limited to this example. For example, the movable end 20a may be fixed to a part of the movable unit 40a (for example, a part different from the image sensor 11). Alternatively, the fixed end 20b may be fixed to a part of the sensor plate 29. That is, the movable end 20a of the heat conductive member 20 may be fixed to the movable unit 40a, and the fixed end 20b may be fixed to at least one of the base member 13c or the sensor plate 29.

In a case where the fixed end 20b is fixed to the base member 13c, the base member 13c functions as the fixed member. On the other hand, in a case where the fixed end 20b is fixed to the sensor plate 29, the sensor plate 29 functions as the fixed member.

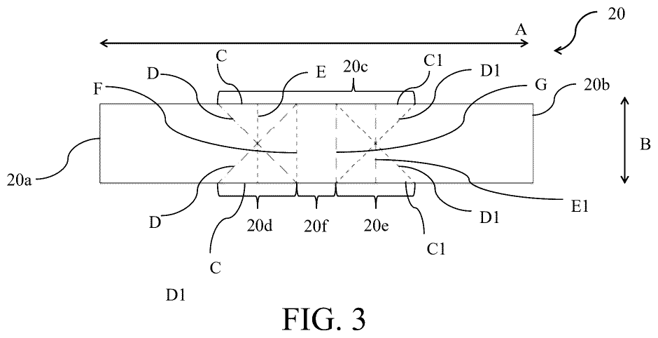

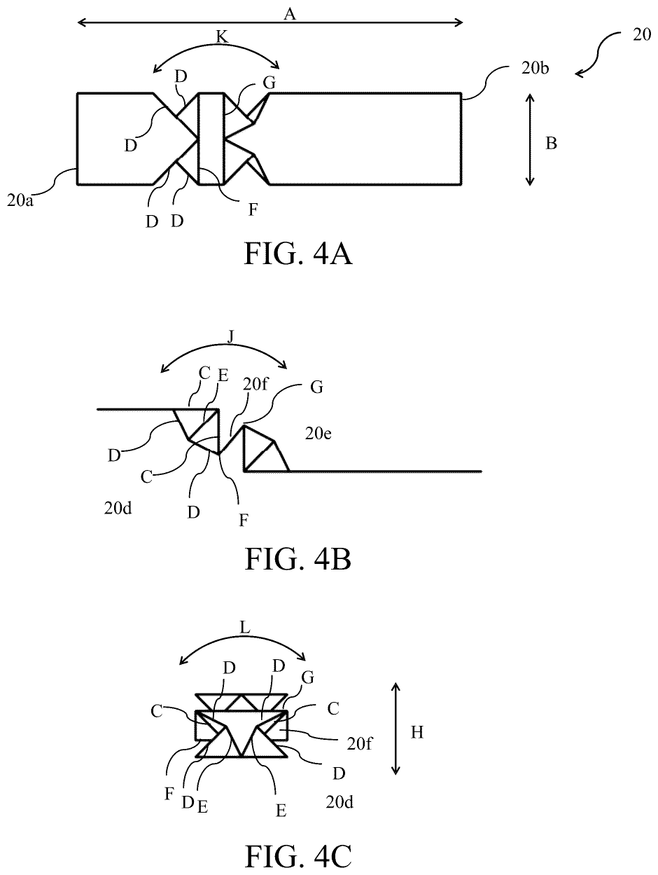

Referring now to FIGS. 3 to 4C, a description will be given of an ideal folding method of the expandable portion 20c and the method of generating degrees of freedom about the axis of the expandable portion 20c. FIG. 3 is a developed view of the expandable portion 20c. FIGS. 4A, 4B, and 4C illustrate the heat conductive member 20 with the expandable portion 20c folded from three directions using trigonometry.

As illustrated in FIG. 3, the movable end 20a is located at the left end of the heat conductive member 20, the fixed end 20b is located at the right end, and the expandable portion 20c is located between them. Here, a direction from the movable end 20a toward the fixed end 20b is a heat transfer direction A (first direction), and a direction orthogonal to the heat transfer direction A on the plane of the heat conductive member 20 is an orthogonal direction B (second direction). The expandable portion 20c has a first folded portion 20d, a second folded portion 20e, and a bellows portion (flat portion) 20f arranged between the first folded portion 20d and the second folded portion 20e. The first folded portion 20d, the bellows portion 20f, and the second folded portion 20e are arranged along the heat transfer direction A.

The first folded portion 20d is a quadrangle (rectangle) having opposing end surfaces C of the heat conductive member 20 as opposing sides. Two diagonals D of the quadrangle of the first folded portion 20d are mountain fold lines, and a line segment E (a line dividing a triangle) that bisects the triangle with the end surface C formed by folding the diagonal D as the base is a valley fold line.

The second folded portion 20e is a quadrangle (rectangle) having opposing end surfaces C1 of the heat conductive member 20 as opposing sides. Two diagonals D1 of the quadrangle of the second folded portion 20e are mountain fold lines, and a line segment E1 that bisects the triangle with the end surface C1 formed by folding the diagonal D1 as the base is a valley fold line. In this way, the second folded portion 20e has the fold lines of the first folded portion 20d reversed when viewed from the same surface of the heat conductive member 20, but has the same configuration when viewed from the back.

A boundary line F between the bellows portion 20f and the first folded portion 20d is the same valley fold line (third valley portion) as the line segment E of the first folded portion 20d, and a boundary line G between the bellows portion 20f and the second folded portion 20e is a mountain fold line (fifth mountain portion). That is, a valley fold line (third valley portion) is disposed between the first folded portion 20d and the bellows portion 20f, and a mountain fold line (fifth mountain portion) is disposed between the second folded portion 20e and the bellows portion 20f. Due to this configuration, the heat conductive member 20 has a bellows shape including the first folded portion 20d, the bellows portion 20f, and the second folded portion 20e.

In a case where the expandable portion 20c is folded as described with reference to FIG. 3, the heat conductive member 20 has a shape illustrated in FIGS. 4A, 4B, and 4C. In a case where the movable end 20a moves in the heat transfer direction A, in a thickness direction H orthogonal to each of the heat transfer direction A and the orthogonal direction B, and in a rotation direction J when viewed from the orthogonal direction B, an opening angle of the fold of the line segment E changes, and the entire bellows shape of the expandable portion 20c expands and contracts. Thereby, the movable end 20a can move with a low load.

In a case where the movable end 20a moves in the orthogonal direction B, in a rotational direction K when viewed from the thickness direction H, and in a rotational direction L when viewed from the heat transfer direction A, the opening angle of the fold of the line segment E changes up and down, and the bellows portion 20f rotates in the rotational direction L. Thereby, the movable end 20a can move with a low load.

From the viewpoint of heat transfer efficiency, the length of the expandable portion 20c may be short in the heat transfer direction A and long in the orthogonal direction B. From the viewpoint of manufacturing labor, there may be few folds. Therefore, this embodiment can reduce the load of six degrees of freedom with a minimum number of folds. However, this embodiment is not limited to this example. For example, in a case where the number of folds is not important, the number of folded portions or bellows portions may be increased, or the number of folds in the bellows portion may be increased.

In this embodiment, the heat conductive member 20 is configured to have a Z shape when folded, but it may be configured to have a U turn. At that time, the configuration of the two folded portions may be configured to have the same peaks and valleys when viewed from the same surface, and the folds in the bellows portion are three or more.

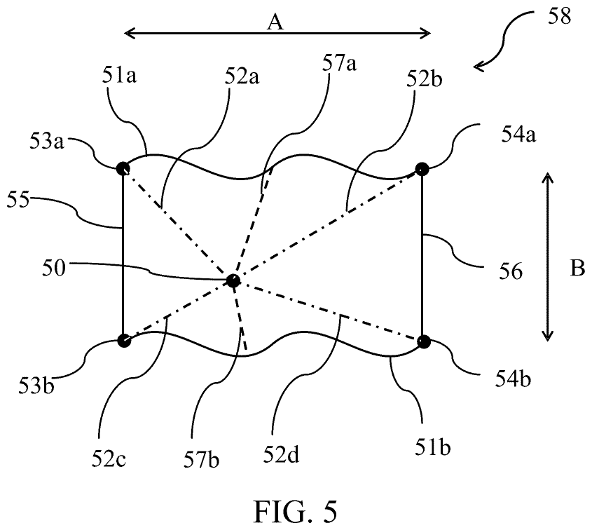

Next, a general definition of the folded portion 58 will be described with reference to FIG. 5. FIG. 5 is a general schematic diagram of the folded portion 58. The folded portion 58 corresponds to the first folded portion 20d and the second folded portion 20e described with reference to FIG. 3 to and 4C, and will be described with a more general shape than that of FIGS. 3 to 4C.

As illustrated in FIG. 5, the folded portion 58 may not be rectangular. The folded portion 58 has two end surfaces (first end and second end) 51a and 51b (corresponding to end surfaces C and C1 in FIG. 3) located at the end of the vertex (predetermined point) 50 located in the expandable portion 20c in the orthogonal direction B. The end surface 51b is a surface opposite the end surface 51a in the orthogonal direction B. In the folded portion 58, mountain fold lines 52a and 52b (corresponding to diagonals D and D1 in FIG. 3) are arranged from the vertex 50 to the end surface 51a. The folded portion 58 also has an intersection 53a between the mountain fold line 52a on the side closer to the movable end 20a and the end surface 51a, and an intersection 54a on the side closer to the fixed end 20b.

Similarly, the mountain fold lines 52c and 52d drawn from the vertex 50 on the end surface 51b side are set, and the respective intersections are set as intersections 53b and 54b. In this case, a straight line connecting the intersections 53a and 53b is a straight line 55, a straight line connecting the intersections 54a and 54b is a straight line 56, and an area enclosed by the two end surfaces 51a and 51b and the straight lines 55 and 56 is the folded portion 58.

A valley fold line 57a is disposed between the two mountain fold lines 52a and 52c from the vertex 50 to the end surface 51a, and is disposed so as to be aligned with the mountain fold line 52a, the valley fold line 57a, and the mountain fold line 52b. Similarly, on the end surface 51b side, the mountain fold line 52c, the valley fold line 57b, and the mountain fold line 52d are arranged so as to be aligned with one another. Due to this configuration, the folded portion 58 can exhibit the same effect as that of the first folded portion 20d and the second folded portion 20e described with reference to FIG. 3 to 4C.

As described above, in this embodiment, the heat conductive member 20 has a folded portion 58. The folded portion 58 has three folds that are aligned in order of the mountain fold line 52a, the valley fold line 57a, and the mountain fold line 52b from the vertex 50 to the end surface 51a in the orthogonal direction B. Furthermore, the folded portion 58 has three folds that are aligned in order of the mountain fold line 52c, the valley fold line 57b, and the mountain fold line 52d from vertex 50 to the end surface 51b.

However, this embodiment is not limited to this example. For example, the folded portion 58 of the heat conductive member 20 may have a configuration in which a valley portion (concave portion) is formed between the two mountain fold lines by forming two adjacent mountain fold lines instead of the configuration in which a valley fold line is provided from the vertex 50 to the end surface 51a or the end surface 51b. In addition, this embodiment forms two valley fold lines 57a and 57b, but is not limited to this example as long as at least one valley fold line or valley portion is formed. That is, the folded portion 58 has the mountain fold lines 52a and 52b from the vertex 50 to the end surface 51a, and mountain fold lines 52c and 52d from the vertex 50 to the end surface 51b. In addition, the folded portion 58 has a valley portion (corresponding to the valley fold line 57a) between the mountain fold lines 52a and 52b (a valley portion (concave portion) is formed between the mountain fold lines 52a and 52b by forming the mountain fold lines 52a and 52b). Alternatively, the folded portion 58 may have a valley portion (corresponding to the valley fold line 57b) between the mountain fold lines 52c and 52d, rather than between the mountain fold lines 52a and 52b. This embodiment may have a reverse relationship between the mountain fold lines (mountain portions) and the valley fold lines (valley portions) may be reversed.

This embodiment can provide an image pickup apparatus that can reduce a movement load of a movable member that is movable not only in a direction different from the optical axis 12a (an optical-axis orthogonal direction) but also in a direction parallel to the optical axis 12a (the optical axis direction) without increasing the length of the path of the heat conductive member 20 (while considering the heat dissipation efficiency).

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This embodiment can provide an image pickup apparatus that can reduce the movement load of a movable member in both the optical axis direction and the optical-axis orthogonal direction while considering the heat dissipation efficiency.

This application claims the benefit of Japanese Patent Application No. 2024-139249, which was filed on Aug. 20, 2024, and which is hereby incorporated by reference herein in its entirety.

What is claimed is:

1. An image pickup apparatus comprising:
a fixed unit;
a movable unit movably held relative to the fixed unit and having an image sensor; and
a heat conductive member configured to dissipate heat in a first direction from the movable unit to the fixed unit,
wherein the heat conductive member includes a folded portion that includes:
three folds arranged in order of a first mountain portion, a first valley portion, and a second mountain portion from a predetermined point to a first end in a second direction orthogonal to the first direction, and
three folds arranged in order of a third mountain portion, a second valley portion, and a fourth mountain portion from the predetermined point to a second end opposite to the first end.

2. The image pickup apparatus according to claim 1, wherein the folded portion includes a first folded portion and a second folded portion arranged along the first direction.

3. The image pickup apparatus according to claim 2, wherein the heat conductive member has a flat portion arranged between the first folded portion and the second folded portion.

4. The image pickup apparatus according to claim 3, wherein the heat conductive member has a bellows shape including the first folded portion, the flat portion, and the second folded portion.

5. The image pickup apparatus according to claim 4, wherein a third valley portion is formed between the first folded portion and the flat portion, and
wherein a fifth mountain portion is formed between the second folded portion and the flat portion.

6. The image pickup apparatus according to claim 1, wherein the folded portion is a rectangle,
wherein the first mountain portion, the second mountain portion, the third mountain portion, and the fourth mountain portion are arranged on a diagonal of the rectangle, and
wherein the first valley portion and the second valley portion are arranged on a line that divides a triangle formed by the diagonal.

7. An image pickup apparatus comprising:
a fixed unit;
a movable unit movably held relative to the fixed unit and having an image sensor; and
a heat conductive member configured to dissipate heat from the movable unit to the fixed unit,
wherein the heat conductive member includes a folded portion that includes:
a first mountain portion and a second mountain portion from a predetermined point to a first end,
a third mountain portion and a fourth mountain portion from the predetermined point to a second end, and
a first valley portion between the first mountain portion and the second mountain portion.

8. The image pickup apparatus according to claim 7, wherein the folded portion has a second valley portion between the third mountain portion and the fourth mountain portion.

9. The image pickup apparatus according to claim 1, wherein the movable unit is movable in an orthogonal direction orthogonal to an optical axis in an imaging optical system.

10. The image pickup apparatus according to claim 9, wherein the fixed unit has a first fixed member and a second fixed member,
wherein the movable unit is movable relative to the second fixed member in the orthogonal direction,
wherein a distance in an optical axis direction between the movable unit and the second fixed member is maintained constant, and
wherein a distance in the optical axis direction between the first fixed member and the second fixed member is adjustable.

11. The image pickup apparatus according to claim 10, wherein the second fixed member is held by a holding member via an elastic member movably in the optical axis direction relative to the first fixed member.

12. The image pickup apparatus according to claim 10, wherein a first end of the heat conductive member is fixed to the movable unit, and
wherein a second end of the heat conducive member is fixed to at least one of the first fixed member and the second fixed member.
